(19) United States
(12) Patent Application Publication
(10) Pub. No.: US 2023/0097969 A1
(43) Pub. Date: Mar. 30, 2023

(54) METHOD FOR PRODUCING PHOSPHATE DIESTER OR PHOSPHATE TRIESTER

(71) Applicants: SAGA UNIVERSITY, Saga (JP); NIPPON CONCRETE INDUSTRIES CO., LTD., Tokyo (JP)

(72) Inventors: Shin-ichi KAWAGUCHI, Saga (JP); Takeshi SASAKI, Tokyo (JP); Yasuyuki HAYAKAWA, Tokyo (JP)

(73) Assignees: SAGA UNIVERSITY, Saga (JP); NIPPON CONCRETE INDUSTRIES CO., LTD., Tokyo (JP)

(21) Appl. No.: 17/796,824

(22) PCT Filed: Oct. 1, 2020
(86) PCT No.: PCT/JP2020/037458

§ 371 Date: Aug. 1, 2022

(30) Foreign Application Priority Data
Feb. 4, 2020 (JP) 2020-016941

(51) Int. Cl. C07F 9/09; C07F 9/12

(52) U.S. Cl. CPC C07F 9/09; C07F 9/12

(57) ABSTRACT

A method for producing a phosphate diester or a phosphate triester is provided in which the phosphate diester or the phosphate triester can be produced from phosphoric acid and a hydroxy compound. Phosphoric acid and a phenol, which is used in excess with respect to the phosphoric acid, are subjected to dehydrating condensation with heating and refluxing. Water released during this dehydrating condensation is adsorbed onto a dehydrating material, which is an adsorbent derived from concrete sludge, disposed somewhere in the refluxing channel, thereby producing a phosphate diester or a phosphate triester.

### CROSS REFERENCES TO RELATED APPLICATIONS

The present application is a U.S. National Phase Application under 35 U.S.C. § 371 of International Patent Application No. PCT/JP2020/037458, filed Oct. 1, 2020, which claims priority of Japanese Patent Application No. 2020-016941, filed Feb. 4, 2020. The entire contents of which are hereby incorporated by reference.

### TECHNICAL FIELD

The present invention relates to a method for producing phosphate diester or phosphate triester.

### BACKGROUND

Phosphate ester is used as a flame retardant, a plasticizer, and a thickener for plastics, and used in various applications in automotive industry, aircraft industry, computer manufacturing, building wall materials, and the like. Furthermore, tributyl phosphate, one of phosphate ester, is also used in nuclear-related fields, for example, used for extraction solutions in a nuclear fuel cycle.

Conventionally, phosphate ester is produced from yellow phosphorus as a starting material into phosphate ester through conversion of phosphorus chloride and phosphorus oxychloride.

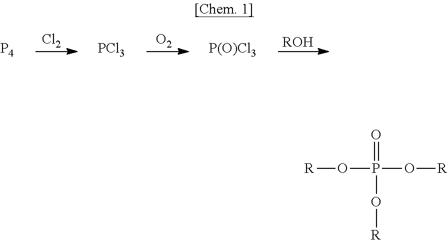

Yellow phosphorus as a starting material is a substance that requires high energy for purification, and it is difficult to obtain yellow phosphorus in Japan because Japan does not produce yellow phosphorus and relies on imports.

On the other hand, phosphoric acid is a final product of a consumption process of phosphorus, and is available in large quantities, but due to lack of chemical conversion means, phosphoric acid of a quality that cannot be used as fertilizers is currently diluted and disposed of, and its effective use is being required.

If phosphate ester can be produced from phosphoric acid as a starting material, consumption of yellow phosphorus that requires high energy can be reduced, and phosphoric acid to be disposed of can also be reduced, thus allowing phosphorus cycle society to be achieved.

For example, general ester can be produced by subjecting carboxylic acid and alcohol to a dehydration condensation reaction by heating under acidic conditions.

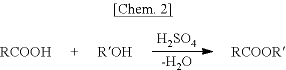

However, such a method cannot be applied to production of phosphate ester using phosphoric acid.

Known methods for producing phosphate ester include a method for producing phosphate ester by reacting phosphoric acid and alcohol in a solvent including an amide compound or a urea compound, using a phosphazene compound as a catalyst (see, for example, Japanese Patent No. 5067752).

### SUMMARY OF INVENTION

In the method mentioned above, phosphate monoester can be produced by allowing a phosphoric acid monoesterification reaction to proceed with a phosphazene compound, but disubstituted ester or trisubstituted ester, i.e., phosphate diester or phosphate triester cannot be produced.

The present invention has been made in view of such a point, and has an object to provide a method for producing phosphate diester or phosphate triester, capable of producing phosphate diester or phosphate triester using phosphoric acid and a hydroxy compound.

### Solution to Problem

A method for producing phosphate diester or phosphate triester as described is a method including: subjecting phosphoric acid and an excess amount of hydroxy compound with respect to the phosphoric acid to dehydration condensation under heating reflux conditions; and adsorbing moisture released during the dehydration condensation with a dehydrating material as an adsorbent derived from concrete sludge placed in a middle of a reflux.

The method for producing phosphate diester or phosphate triester is the method for producing phosphate diester or phosphate triester as described above, wherein the hydroxy compound is aromatic alcohol or phenols.

The method for producing phosphate diester or phosphate triester is the method for producing phosphate diester or phosphate triester as described above, wherein a solvent having a higher boiling point than that of water is used.

The method for producing phosphate diester or phosphate triester of claim 4 is the method for producing phosphate diester or phosphate triester as described, wherein the excess amount of amine with respect to phosphoric acid is used as a phosphoric acid solubilizer to the solvent.

The method for producing phosphate diester or phosphate triester is the method for producing phosphate diester or phosphate triester as described above, wherein the amine has a higher boiling point than that of water.

According to the present invention, phosphate diester or phosphate triester can be produced using phosphoric acid and a hydroxy compound.

### BRIEF DESCRIPTION OF DRAWINGS

FIG. 1 is a perspective view showing a production device for producing phosphate diester or phosphate triester of the Examples.

### DETAILED DESCRIPTION

Hereinafter, an embodiment of the present invention will be described.

In this embodiment, phosphate ester is produced by subjecting phosphoric acid and a hydroxy compound as a starting material to dehydration condensation while stirring under heating reflux conditions. At the time, in this embodiment, at least one of a solvent, a phosphoric acid solubilizer, and a catalyst is used as necessary.

As phosphoric acid, orthophosphoric acid is used. Phosphoric acid is a final product of a phosphorus consumption process, and is easily available in large quantities. Phosphoric acid may include moisture.

As the hydroxy compound, aromatic alcohol or phenols are used. In this embodiment, as the hydroxy compound, phenol is suitably used.

The solvent acts as a carrier for removing water during dehydration condensation. As the solvent, a solvent having a boiling point higher than that of water is used. Suitable examples of solvents include formamide such as dimethylformamide (DMF). Other examples of solvents may include toluene, dimethyl sulfoxide (DMSO), dioxane, n,n-dimethyl acetamide, xylene, 1,1,2-trichloroethane, 1,1,2,2-tetrachloroethane, and the like.

The phosphoric acid solubilizer has a role as a leaving group for facilitating a condensation reaction of phosphoric acid and a role for improving nucleophilicity of aromatic alcohol or phenols to phosphorus, in addition to a role for solubilizing phosphoric acid to the solvent. As the phosphoric acid solubilizer, amine is used suitably, and more preferably amine having a higher boiling point than that of water is used. For example, as amine, trialkylamine such as tri-n-butyl amine is suitably used.

As the catalyst, preferably, nonvolatile catalysts are used. As the catalyst, for example, alkyl imidazoles such as n-butylimidazole are used. In addition, as the catalyst, a pyridine-based catalyst may be used.

In this embodiment, moisture as a byproduct released during condensation of phosphoric acid and a hydroxy compound is adsorbed by a dehydrating material. As the dehydrating material, a molecular sieve and the like may be used, but in this embodiment, an adsorbent derived from concrete sludge is suitably used.

Phosphate ester to be generated includes at least one of phosphate diester and phosphate triester. Specifically, phosphate ester to be generated in this embodiment includes, for example, diphenyl phosphate and triphenyl phosphate. The phosphate ester to be generated may include phosphate monoester. This phosphate ester is generated from the following reaction formula.

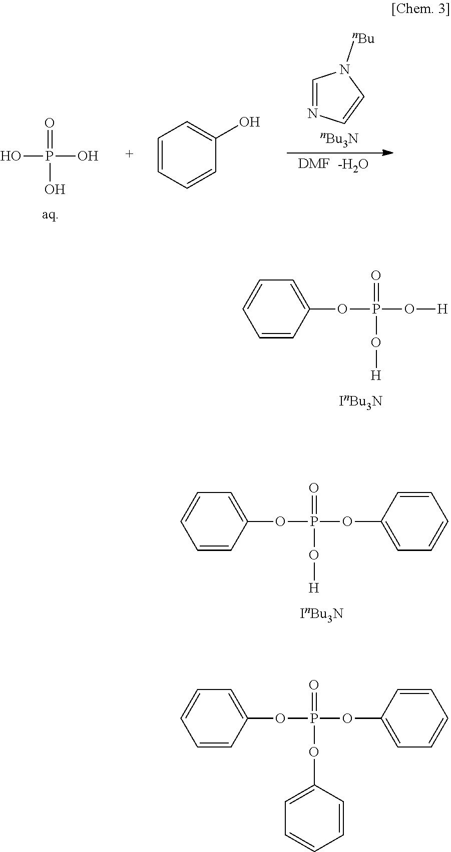

In the reaction formula, the hydroxy compound is preferably used in an excess amount, that is, in an amount of more than one equivalent with respect to phosphoric acid. The equivalent amount of the hydroxy compound with respect to the phosphoric acid is set depending on the type and yield of phosphate ester to be produced, in other words, the ratio of phosphate diester or phosphate triester. For example, in this embodiment, phenol is used in about 5 to 10 equivalents with respect to phosphoric acid.

Also, preferably, the phosphoric acid solubilizer is used in an excess amount, that is, in an amount of more than one equivalent with respect to phosphoric acid. The equivalent amount of the phosphoric acid solubilizer with respect to phosphoric acid is set depending on the type and yield of phosphate ester to be produced. For example, in this embodiment, tri-n-butyl amine is used in about 3 to 5 equivalents with respect to phosphoric acid.

The catalyst is used in 1 equivalent or less, for example, 0.1 to 1 equivalents with respect to phosphoric acid.

A reaction temperature of the dehydration condensation is, for example, 110° C. to 180° C., but the temperature may be appropriately changed depending on solvents.

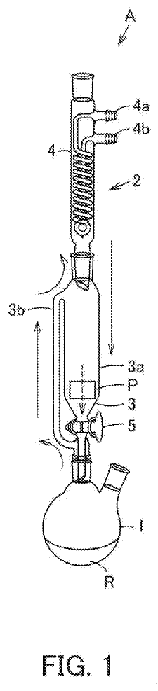

In production of the phosphate ester mentioned above, for example, a reactor vessel A as shown in FIG. 1 is used.

A reactor vessel A is a heat reflux device. The reactor vessel A includes a flask 1 and an extractor 2 connected to the flask 1. The flask 1 contains a reaction solution R including predetermined amounts of phosphoric acid, phosphoric acid solubilizer, solvent, and catalyst. Furthermore, the flask 1 may contain a stirring bar for stirring the reaction solution R. One example of the extractor 2 to be used is a Soxhlet extractor. The extractor 2 includes an extractor main body 3 having a first end portion to which a cooler 4 is connected. To a second end of the extractor main body 3, the flask 1 is connected. As the cooler 4, for example, a Dimroth condenser tube is used. In the cooler 4, cooling water as a refrigerant is introduced from an introduction portion 4a and discharged from a discharge portion 4b. A dehydrating material P is contained in a main body tube 3a of the extractor main body 3, and a cock 5 is interposed between the main body tube 3a and the flask 1. In other words, the dehydrating material P is placed in a middle of a reflux. Furthermore, the extractor main body 3 has a branch tube 3b branched from the main body tube 3a. The branch tube 3b has a first end connected to the main body tube 3a in a position nearer to a flask 1 side from the cock 5, and a second end connected to the main body tube 3a in a position nearer to a cooler 4 side of the main body tube 3a.

In the reactor vessel A including a flask 1 in the lower side and an extractor 2 in the upper side, a lower part of the flask 1 is immersed in, for example, an oil bath provided to a heating and stirring device such as a stirrer, and the reaction liquid R in the flask 1 is heated to a predetermined temperature while being stirred. A solvent evaporated from the flask 1 rises from the branch tube 3b of the extractor main body 3 to the cooler 4, cooled by the cooler 4, drops to the main body tube 3a of the extractor main body 3, and flows back to the flask 1 through the cock 5 as shown by arrows in the drawing. At this time, moisture as the byproduct is adsorbed by the dehydrating material P contained in the main tube 3a, and thereby, the reaction liquid R in the flask 1 is successively concentrated. Thus, the dehydration condensation reaction is allowed to proceed by heating and refluxing while moisture is taken out of the system by the dehydrating material P and the phosphate ester is prevented from returning to phosphoric acid by the equilibrium reaction, and after predetermined time of reaction, phosphate ester including phosphate diester or the phosphate triester is obtained. The resulting phosphate ester is separated by an appropriate method such as silica gel column chromatography. Dehydrating material after use is disposed of as it is.

According to one embodiment, phosphoric acid and an excess amount of hydroxy compound with respect to the phosphoric acid are subjected to dehydration condensation under heating reflux conditions, so that phosphate ester including phosphate diester or phosphate triester can be easily produced.

As a result, phosphate ester including phosphate diester or phosphate triester can be produced by avoiding using yellow phosphorus mainly imported in supply of raw materials.

Furthermore, when phosphate ester is produced by using yellow phosphorus, since hydrochloric acid is generated as a byproduct, hydrochloric acid need be disposed of. On the other hand, according to this embodiment, since hydrochloric acid is not generated, hydrochloric acid need not be disposed of.

By using phosphoric acid, which is potentially easily available in large quantities, as a raw material, phosphoric acid may not be disposed of, so that phosphoric acid that is an exhaustible resource can be recycled.

By adsorbing the moisture released during the condensation reaction by the dehydrating material placed in the middle of the reflux to trap water as the byproduct in the middle of the reflux and by preventing phosphate ester from returning to the phosphoric acid by the equilibrium reaction, the reaction efficiency is enhanced, and thus, the productivity of phosphate ester can be further improved.

Furthermore, when the adsorbent derived from concrete sludge is used as a dehydrating material, for example, as compared with dehydrating materials such as a molecular sieve, low cost and high absorption can be achieved, and the productivity of phosphate ester can further be improved.

In addition, when aromatic alcohol or phenols having different reactivity from that of aliphatic alcohol are used as the hydroxy compound, the dehydration condensation reaction with phosphoric acid is allowed to proceed effectively, phosphate ester including phosphate diester or phosphate triester can be efficiently produced. In particular, aromatic phosphate ester can be used for flame retardants effectively.

Furthermore, when a solvent having a higher boiling point than that of water is used in dehydration condensation, a reaction temperature of the dehydration condensation can be set to 100° C. or higher, so that the dehydration condensation reaction can be appropriately facilitated.

Furthermore, when an excess amount of amine with respect to phosphoric acid is used as a phosphoric acid solubilizer to a solvent, the dehydration condensation reaction between phosphoric acid and the hydroxy compound (aromatic alcohol or phenols in this embodiment) is allowed to proceed effectively, phosphate ester including phosphate diester or phosphate triester can be produced efficiently. In particular, when amine having a higher boiling point than that of water is used as the amine to be used as the phosphoric acid solubilizer, a reaction temperature in the dehydration condensation can be set at 100° C. or higher and the dehydration condensation reaction can be appropriately promoted.

In other words, in this embodiment, using an excess amount of aromatic alcohol or phenols and an excess amount of phosphoric acid solubilizers with respect to phosphoric acid, dehydration condensation of phosphoric acid and aromatic alcohol or phenols is carried out under heating reflux conditions while water as a byproduct is taken out of the system with the dehydrating material, so that phosphate ester including phosphate diester as disubstituted ester or phosphate triester as trisubstituted ester can be efficiently produced.

1. A method for producing phosphate di ester or phosphate triester, the method comprising:
subjecting phosphoric acid and an excess amount of hydroxy compound with respect to the phosphoric acid to dehydration condensation under heating reflux conditions; and
adsorbing moisture released during the dehydration condensation with a dehydrating material as an adsorbent derived from concrete sludge placed in a middle of a reflux.

2. The method for producing phosphate diester or phosphate triester according to claim 1, wherein the hydroxy compound is aromatic alcohol or phenols.

3. The method for producing phosphate diester or phosphate triester according to claim 1, wherein a solvent having a higher boiling point than a boiling point of water is used.

4. The method for producing phosphate diester or phosphate triester according to claim 3, wherein an excess amount of amine with respect to phosphoric acid is used as a phosphoric acid solubilizer to a solvent.

5. The method for producing phosphate diester or phosphate triester according to claim 4, wherein the amine has a higher boiling point than a boiling point of water.

6. The method for producing phosphate diester or phosphate triester according to claim 2, wherein a solvent having a higher boiling point than a boiling point of water is used.

7. The method for producing phosphate diester or phosphate triester according to claim 6, wherein an excess amount of amine with respect to phosphoric acid is used as a phosphoric acid solubilizer o a solvent.

8. The method for producing phosphate diester or phosphate triester according to claim 7, wherein the amine has a higher boiling point than a boiling point of water.
